(19) United States
(12) Patent Application Publication
(10) Pub. No.: US 2001/0033550 A1
(43) Pub. Date: Oct. 25, 2001

(54) Physical layer auto-discovery for management of network elements

(76) Inventors: Thomas Clyde Banwell, Madison, NJ (US); Nim Kwan Cheung, Short Hills, NJ (US); Phiroz Madon, Old Bridge, NJ (US)

Correspondence Address: Orville R. Cockings, Esq., Telcordia Technologies, Inc., 445 South Street, Morristown, NJ, 07960, US

(21) Appl. No.: 09/771,313

(22) Filed: Jan. 27, 2001

Related U.S. Application Data
(60) Provisional application No. 60/179,002, filed on Jan. 28, 2000.

(51) Int. Cl. H04L 12/28

(52) U.S. Cl. 370/254; 370/465

(57) ABSTRACT

Method and system for providing autonomous real time updates of a network topology. The method is based on a physical layer point-to-point protocol residing in each network element. Either responsive to a request from a network management system or responsive to network trigger event a network initiates a request to its neighboring network elements. The neighboring network elements respond to the request by identifying themselves via an electronic serial number and the port by which they are connected to the requesting network element. The requesting network element then forwards the response to the request to a network management system. The network management system then use the responses to construct a network topology.

### RELATED APPLICATIONS

The present application claims the benefit of U.S. Provisional Application No. 60/179,002 filed on Jan. 28, 2000 and entitled “Method and System to Support Interoperable Network Elements in an Optical Network”.

### FIELD OF THE INVENTION

This invention generally relates to the operation and management of telecommunications network and more specifically to the operation and management of network elements within the public switched telephone network.

### BACKGROUND

A network may be considered to be a collection of network elements that communicate with each other over physical links or paths. The network elements can be routers, switches, multiplexer/demultiplexers, etc. The physical links or paths can comprise copper cable, coaxial cable, or fiber cable. In addition to the network elements and links, the network also comprises a group of network management systems that perform the task of operating, administering, managing, and provisioning the network elements. From the view of the network management system the links or paths and network elements form a network topology which includes a hierarchical structure. As such, when new services are requested network management systems are used to modify the settings in the appropriate network elements, establish new links, and update the network topology.

In order to adequately manage a network, a network management system (NMS), such as a provisioning system, needs to have an accurate view of the network topology in a database. The network topology database typically contains objects representing specific network elements (NEs), links, and their connectivity. When the configuration of the real network changes, the network topology database must be changed in order to accurately track it.

Currently, the method for updating the network topology database is largely manual, particularly in the case of optical networking physical layer equipment (e.g., Wavelength Division Multiplex (WDM), Synchronous Optical NETwork (SONET), network elements) and links. For example, if a new SONET network element is installed or attached to the network, associated network topology equipment has to be manually entered into the associated network management system. If there is a fiber link change, this too needs to be manually updated into the network management system; and so on. Because the process is manual, the update system is labor-intensive, and prone to error. It is common to have the network management system view of the network topology either lagging behind the real network, or running ahead of it, or being just incorrect. Further, the traditional process of introducing a new network element to a network or establishing a new path may take weeks, even months. In addition, entering physical link information into the topology database presents several other problems affecting accuracy.

Network element auto-discovery is currently available for network elements having Internet Protocol (IP) layer functionality. Specifically, as part of its protocol IP provides auto-discovery functionality which allows an IP router, for example, to gather the IP address of each IP layer equipment that is attached to that router. More specifically, the Internet protocol suite provides highly structured tools that can be used to support network auto-discovery, most notably: the IP address, which uniquely identifies hosts, routers, ports, and networks; utilities such as ping; and Signaling Network Management Protocol (SNMP). IP auto-discovery functionality therefore allows a network management system operating in the IP domain to construct the topology of the IP network by simply communicating with the network elements in the network.

Equivalent auto-discovery functionality is available for optical equipment operating at the physical layer. Thus, an network management system cannot automatically discover which physical link connects two network elements and which ports are involved in the connection. Furthermore, there are multiple interrelated circuits at multiple protocol domains or layers: Wavelength Division Multiplex (WDM), Synchronous Optical NETwork (SONET), Asynchronous Transfer Mode (ATM), Internet Protocol (IP) to name a few. Moreover, each protocol domain (i.e., each layer of the protocol stack) is typically managed by a separate network management system within a different network management sector. Finally, network management systems do not talk to each other.

To further illustrate the prior art limitations discussed above we refer to an illustrative network 100 as is shown in FIG. 1. FIG. 1 depicts a SONET network 110 that is used as higher rate transport path between IP routers 112 and 113. The IP routers in essence use the SONET network 110 to establish IP link 117. The figure also illustrates each domain being managed by different network management systems. Specifically, IP-Layer network management system 130 is only able to see the IP routers 112 and 113 in the network. In contrast, optical layer network management system 140 is only able to see the optical layer network elements 119. The optical layer network elements 119 are invisible to the IP layer network management system and the IP routers are invisible to the optical layer network management system 140. Thus, the result of an auto-discovery probe from network management system 130 would show only IP router 112 connected to IP router 113. In short, the entire SONET network 110 appears to the IP-Layer network management system as a single abstract IP link 117. Clearly, to be able to manage a multiple-protocol domain network, the network management system 130 should be able to find all the network elements by using auto-discovery.

Of utility then is a method and system that allows network management functionality across multiple network protocol domains.

### SUMMARY

Our invention is a method and system for automatically discovering optical layer network elements.

In accordance with an aspect of our invention network elements comprising a network are each assigned a unique electronic serial number. In addition each port on a network element is uniquely defined. The unique port identifier and electronic serial number are then used by a point-to-point physical protocol to discover neighboring network elements. Each time a network element is connected to another network element via a physical link, each network element is able to determine the electronic model number, serial number and port identifier for the network element (NE) at the far end of the link. The network element subsequently sends this information to the network management system (NMS). The network management system is then able to use the information contained in the messages to construct a topology of the network.

Because our invention advantageously operates at the lowest layer all the network elements comprising a network are automatically discovered. Specifically, in accordance with an aspect of our invention optical layer network elements as well as higher-layer network elements are automatically discovered. As such, a network management system implemented in accordance with our invention can acquire a more complete view of the entire network topology.

In accordance with another aspect of our invention network operators not desiring a complete view of the network topology may appropriately filter the discovered network topology.

Our invention operates autonomously and may be initiated by the network management system or the network elements within a network. The autonomous nature of our invention overcomes the prior art shortcomings by allowing for almost instantaneous updates of a network topology in response to the addition of a new network element or the addition or turning up a new link.

### BRIEF DESCRIPTION OF THE DRAWINGS

FIG. 1 depicts prior art network management systems and subject network elements;

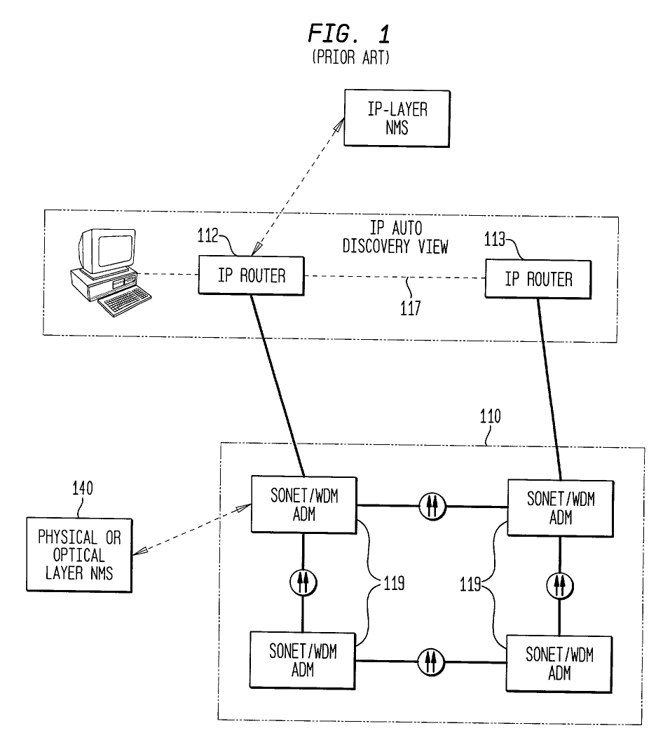

FIG. 2 is a high level illustration of our invention;

FIG. 3 illustratively depicts our method for uniquely identifying a network element in accordance with an aspect of our invention;;

FIG. 4A depicts the format of a request packet used accordance with an aspect of our invention;

FIG. 4B depicts the format of a response packet used in accordance with an aspect of our invention;

FIG. 5A depicts the method steps of an network management system initiated update in accordance with an aspect of our invention; and

FIG. 6 illustrates an exemplary network operating in accordance with our invention.

### DETAILED DESCRIPTION

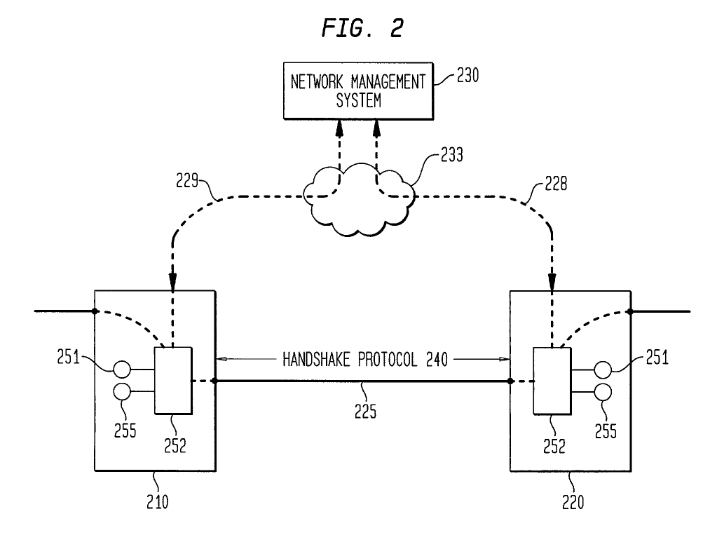

Turning to FIG. 2 there is depicted a high level view of an exemplary network in accordance with our invention. In FIG. 2 a first network element (NE) 210 is communicating with a second network element 220 over a link 225. Link 225 is preferably an optical link. As will become clearer below, the first and second network elements may be in different domains; for example, network element 210 may be an IP router or host whereas network element 220 may be a SONET Add Drop Multiplexer. Both network elements 210 and 220 are connected via links 228 and 229 to a network management system 230. The connection 229 is done using an Operating System/Network Element (OS/NE) protocol such as SNMP for IP domain network elements and TL-1 for SONET equipment. In addition, the network management system 230 is connected either directly or indirectly to each network element 210 and 220 via a data network 233. Although we show each network element connected to in FIG. 2 those skilled in art will recognize that a network management system is usually able to indirectly communicate with several other network elements through the network element, so called gateway, that the network management system is directly connected to.

Each network element is seen exchanging, in accordance with our nomenclature, a hand-shake protocol 240. By use of the hand-shake protocol 240, along with the other aspects of our invention described below in more detail, our invention allows all the network elements comprising a network to be automatically discovered which in turn allows the network management system 230 to develop a complete view of the topology of the network across many network domains.

In addition to the hand-shake protocol 240 mentioned above, other aspects of our invention include a method for uniquely identifying a network element and an optical port on the network element and a method wherein each network element, either responsive to a request from a network management station or a self instantiated command/request, provides its identification, the identification of each optical port on the subject network element, and for each port connected to a link, the identification of the port at the far end of the fiber (the far end network element identification and the far end port identification).

In addition, each network element in FIG. 2 has functionality for encoding of an electronic model and serial number in accordance with an aspect of our invention as is illustrated by functional block 251. Block 251 is connected to a processor 252. Processor 252 is used in executing handshake protocol 240. Processor 252 also has as another input functional block 255. Block 255 is a physical layer auto-discovery functional module that can be initiated by network management system 230 or the network element in which it resides.

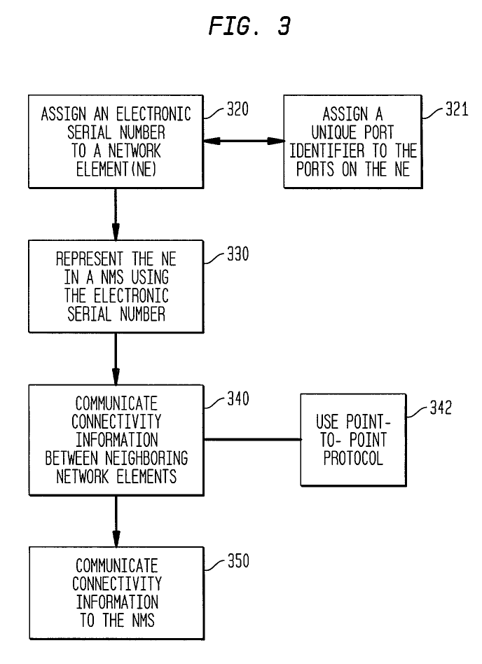

Turning to FIG. 3 there is illustrated our method for uniquely identifying a network element in a vendor or supplier neutral manner. At block 310 a network element is assigned two values: a network element model number and a network element serial number. These values are intended to uniquely identify each network element in much the same way that each cellular phone is uniquely identified. As such, we refer to these values as a network element's electronic serial number.

At block 320 the assigned model number and serial number are electronically encoded on the network element. The model number and serial may be advantageously represented by a character string in the network element. This step requires each network element to possess the intelligence to realize or know of its own electronic serial number. Although currently each network element in the Public Switched Telephone Network (PSTN) is assigned a Common Language Equipment Identification (CLEI) codes and a Common Language Location Identification (CLLI) codes, those codes or values are not presently electronically encoded in the associated network element. More importantly, the current manual process of updating the network topology database is the precisely the process of associating the proper CLEI and CLLI code with proper links in the network.

Nonetheless, already existing values or codes, such as CLEI or CLLI code, can be used as an electronic serial number as long as the equipment possess the intelligence to know or recognize its own serial number and the serial number of other equipment. In short, the prior art is devoid of network elements that have the functionality that allows encoding of an electronic serial number for the purpose of our inventive concept. This functionality is illustrated in FIG. 2 as a software module 251 that runs on a processor 252.

In addition to each network element having an electronic serial number each port on a network element, in accordance with another aspect of our invention, is assigned a unique port identifier, block 321. Normally, every network element has its own manufacturer's syntax for identifying each port on the network element. In addition, each port on the network element is uniquely identified within this syntax. As such, the manufacturer's unique identifier may be used in accordance with our invention.

At block 330 each network element is represented in the network management system 230 (of FIG. 2) with an object that has the two values that comprise the electronic serial number. The network management system requires knowledge of the electronic serial number so that it (the network management system) it is able to uniquely identify each network element network element within a network. The object representing the network element in the network management system can be loaded with the electronic serial number either automatically or manually. Automatic loading is more advantageous than manual loading since it removes the human error element from the process. Automatic loading would take place the first time the network element is installed in the network and connected to the network management system by having the network element autonomously inform the network management system of its presence. Manual loading of the network management system is not as advantageous as automatic loading, nevertheless manually loading the network element serial number in accordance with our invention represents a significant advance over the current practice. This is the case because only the electronic serial number of the network element needs to be loaded. In accordance with our invention each network element automatically discovers all the other network elements it is connected to and provides this information to an network management system, more precisely in the network topology database.

With each network element having an electronic serial number and each port on the network element being uniquely identified neighboring network elements then automatically communicate their respective connectivity information to each other as is shown at block 340 of FIG. 3. This communication is effected by way of a physical or optical layer auto-discovery function residing in each network element (represented as block 255 of FIG. 2). As previously discussed, while IP layer auto-discovery presently exists at the IP layer for equipment in the IP domain. IP layer auto-discovery is however vendor specific and done at the IP layer. Therefore, equipment operating at lower layers in the OSI stack are invisible using vendor specific auto-discovery tools currently available. In contrast, the physical layer is the lowest layer in the OSI stack thus auto-discovery at the physical layer illuminates equipment operating at the other higher layers in the stack - more importantly in the network.

The communication that takes place between neighboring network elements can be accomplished by a point-to-point protocol whereby a network element queries its neighbor across a link, for example an optical link, for configuration information at the far end. The configuration information requested by each network element of its neighbor comprises the subject network element serial number and the unique identifier of the far-end network element's port that connected to the requesting network element.

In accordance with another aspect of the present invention we developed a Far-End Protocol for communicating connectivity information or network element data between neighboring network elements. In accordance with our Far-End protocol communications between a network element and its neighbor across a link is via 256 byte packets. In the bit stream in each direction the packets are demarcated by using standard Zero Bit Insertion/Deletion (ZBID) flags, such as is done in the HDLC protocol. Each communication transaction consists of a request packet and a response packet.

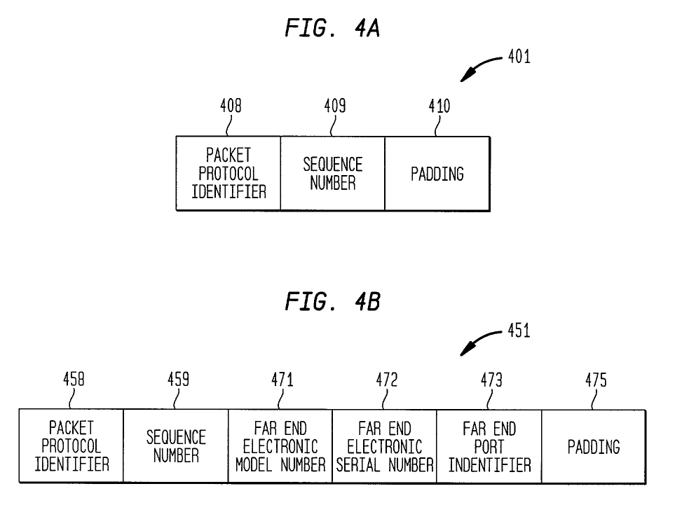

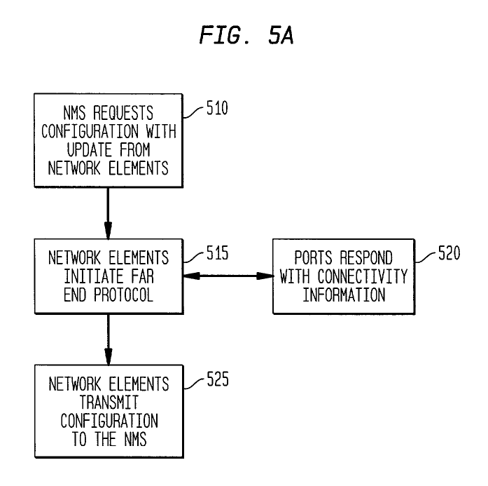

The format of our Request Packet 401 is shown in FIG. 4A. As FIG. 4A shows the request packet comprise a PacketProtocolIdentifier 408, a SequenceNumber 409, and Padding 410. The Packet Protocol Identifier 408 is a fixed ASCII character string to indicate that the packet is a far-end protocol request packet. It is a fixed ASCII strings that reads FarEndProtocolRequest. The sequence number 409 is an integer that uniquely identifies a request-response sequence. It is incremented by the requesting network element for each new request-response transaction. After reaching the maximum, this integer wraps around. We allocated four bytes for the sequence number. The padding consists of ASCII blanks to make the packet 256 bytes long. For clarity we include Table 1 below which contains a summary of the function and format of the request packet.

TABLE 1

| Field | Function | Format |
|---|---|---|
| PacketProtocol | This is just a fixed ASCII character string to indicate | FarEndProtocol |
| Identifier | that this is a Far End Protocol request packet. It is a | Request (20 bytes) |
| | fixed ASCII string which reads: FarEndProtocolRequest | |
| SequenceNumber | This number uniquely identifies a request-response | Integer (4 bytes). |
| | sequence. It is incremented by the Requesting NE for | |
| | each new request-response transaction. After reaching | |
| | the maximum, this integer wraps around. | |
| Padding | Padding to make the packet 256 bytes | ASCII blanks (231 |
| | | bytes) |

In FIG. 4B we show the format of our response packet 451 which comprises a PacketProtocolIdentifier 458, a SequenceNumber 459, FarEndElectronicModel Number 471, FarEndElectronicSerial Number 472, FarEndPortIdentifier 473, and Padding 475. Packet Protocol Identifier 458 is a fixed ASCII character string to indicate that this is a Far End Protocol response packet. Sequence Number 459 is the same 4-byte Sequence Number sent by the request packet to which this is a response. Far End Electronic Model Number 471 is an ASCII-encoded electronic model number of the network element product at the far-end. ASCII-encoded Electronic Serial Number of the network element product at the far-end. Far End Electronic Serial Number 472 is an ASCII-encoded electronic serial number of the network element product at the far-end. Far End Port Identifier 473 is a port number, using manufacturer's syntax, which uniquely identifies the port at the far end. Padding 475 is a 38 byte ASCII blank string to make the packet 256 byte in length. For clarity we included Table 2 below which summarizes the fields, functionality, and format of a response packet.

TABLE 2

| Field | Comment | Format |
|---|---|---|
| PacketProtocol | Fixed ASCII character string to indicate that this is a Far | FarEndProtocol |
| Identifier | End Protocol response packet. | Response |
| SequenceNumber | The same 4-byte SequenceNumber sent by the Request | Integer (4 bytes). |
| | Packet to which this is a response. | |
| FarEndElectronic | ASCII-encoded Electronic Model Number of the NE | Char (64 bytes). |
| ModelNumber | product at the far-end. | Left-justified, |
| | | padded with |
| | | blanks. |
| FarEndElectronic | ASCII-encoded Electronic Serial Number of the NE | Char (64 bytes) |
| SerialNumber | product at the far-end. | left-justified, |
| | | padded with |
| | | blanks. |
| FarEndPort Identifier | Port number, using manufacturer's syntax, which | Char (64 bytes) |
| | uniquely identifies the port at the far end. | left-justified, |
| | | padded with |
| | | blanks. |
| Padding | Padding to make the packet 256 bytes | ASCII blanks (38 |
| | | bytes) |

Where a network element does not respond in a timely manner to a request packet a fixed time-out of approximately one minute is allowed by the requesting network element. We chose one minute for our timeout timer because our protocol is for communication between neighboring network elements. Nonetheless, a timeout time of less than or more than minute may be appropriate depending on the circumstances. In addition, in accordance with this aspect of our invention for a response packet to be accepted as valid by the requesting network element, the packet must arrive in one minute and must have a matching sequence number. Otherwise the packet is discarded.

With the network elements able to exchange connectivity information among themselves, that connectivity information may then be communicated to the network management system as is shown at block 350 of FIG. 3. There are two methods for updating the network topology information in the network management system. One method is network management system-initiated and the other is network element initiated. Both types of updates function concurrently. The network element initiated update ensures that the network-topology information in the network management system is always up-to-date. The network element initiated update is event-triggered, e.g., when a fiber link is connected into a port of the network element. The network management system-initiated update is useful for establishing an initial population for the network management system database, and periodic re-synching with the real network topology.

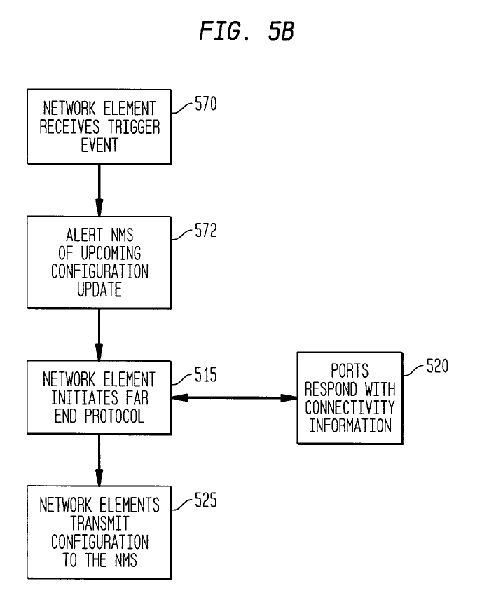

We now turn to FIGS. 5A and 5B to describe network management system-initiated and network element initiated updates of network topology, respectively.

In FIG. 5A, the network management system initiated update begins at block 510 with a network management system requesting a configuration update from each network elements it knows of. As previously discussed the network management system need not be directly connected to each network element that it knows of. As a practical matter, the network management system need only be connected to a gateway network element within each domain and use the gateway network element to communicate to all other network elements within that domain. Further, the protocol for communication between the network management system and the network elements can be any of the standard Operating System/Network Element (OS/NE) protocol such as, for example, SNMP, TL/1, CORBA, or a proprietary protocol.

On receiving a configuration update request the network element uses a point-to-point protocol, such as our far-end protocol, to request connectivity information of all its neighbors, block 515. Ports that are not active, i.e., not connected will result in a null response. Ports that are connected respond with the far-end model number and serial number and the far end port identifier, block 520. The network element then sends the network management system a block of information about itself, block 525. The information then includes the network element model number, network element serial number, and for each connected port on the network element the port identifier, far end network element model number, far end network element serial number, and the far end network element port identifier. If a port is a null then a null packet is sent for that port.

We now turn to FIG. 5B to discuss the method for a process initiated update. At block 570 the method begins with a trigger event. The following events can serve as triggers: the network element is powered up or a link is connected or disconnected. Once the trigger event occurs the network element transmit a message to the network management system to inform the network management system that it will be updating its configuration, block 572. The network element then uses the Far End Protocol to gather a block of information about itself, block 575. The block of information includes the same information gathered at block 525 in FIG. 5A. Specifically, the information includes the network element model number, network element serial number, and for each connected port on the network element the port identifier, far end network element model number, far end network element serial number, and the far end network element port identifier. If a port is a null then the null packet is sent for that port. The network element then sends the block of information to the network management system, block 580

By using the methods described in FIG. 5A and FIG. 5B a network management system acquires more than sufficient information to determine the entire physical layer connectivity of the network. An network management system operating in accordance with our invention is therefore able to automatically keep current with the real network topology as the network evolves.

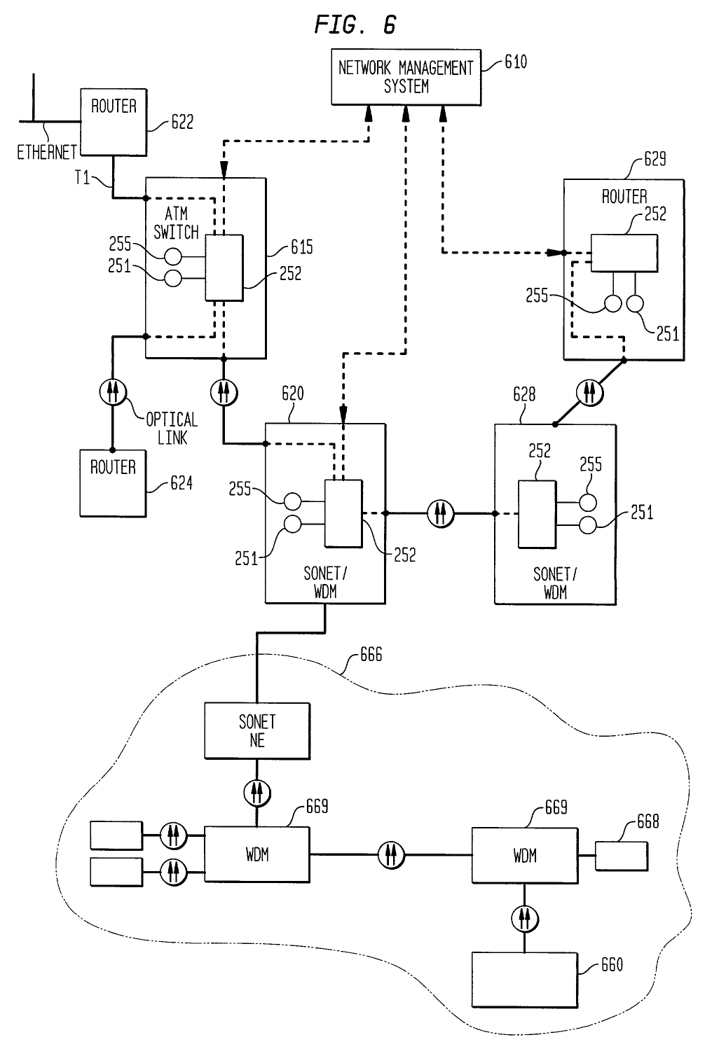

To further clarify our invention, we turn to FIG. 6 which depicts an exemplary network designed and operating in accordance with the aspects of our invention described above. The network of FIG. 6 is merely illustrative and is use only to further explain the benefits and advantages of our invention. FIG. 6 illustrates a network management system 610 communicating with ATM domain, SONET domain, and IP domain network elements. In particular, ATM switch 615 is connected to SONET network element 620, routers 622 and 624, and network management module 610. SONET network element 620 is connected to SONET network element 628 and network management module 210. SONET network element 628 is connected to router 629. Router 629 is also connected to network management system 610. In addition, router 629, network elements 620 and 628, and switch 615 each include auto-discovery functional module 255, processor 252, and electronic serial number module 251.

In addition to communicating with switches, routers and other network elements comprising a network, network management 610 module optionally includes links to downstream fault management, performance management and other administrative systems 650. The information stored in network management system 610 can be used by these systems 650 to perform their respective functions.

In accordance with our invention, the network management function 610 has a topology view of the network that preserves the relationships between the circuits and ports at different layers. Including the relationship between circuit and ports at different layers represents a significant advance over the prior art. This integrated view of the network topology is extremely useful, not only for provisioning and assignments, but also for fault management and performance management. In accordance with our invention, to add a new network element to the network, a network support person wires up the network element as desired. The network management function 610 instantly gets a current topology view of the network, including the new network element. The new network element at the instant it is connected to the existing network is ready for carrying service and can be monitored for performance. If, subsequently, physical links are changed or re-assigned, the network management module reflects the changes in topology within any domain. In accordance with our invention when a network element vendor product hits the market, the software changes required in network management functionality are minimal, or non-existent.

In particular, network management system 610 by being connecting to ATM switch 615, SONET/WDM network element 620, and router 629 can autonomously construct a more accurate network topology. ATM 615 would be able to gain knowledge of all its neighboring network elements 220, 222, and 224 by executing our far end protocol over the OC-3 and T1 links to each of these respective network elements. SONET/WDM 220 network element would be able to relay connectivity information about its neighboring network elements 215 and 228. In addition, router 229 would indicate its connection to network element 228. As previously discussed, the network elements directly connected to the network management system would also serve as gateways to not only it neighbors but to all the subtending network elements that form part of that domain's network. For example, by being connected to SONET/WDM network element 620 the network management system would be able to construct the entire optical network 666 connected to network element 620.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

We claim:

1. A system for managing a network comprising:
a first network element;
a second network element connected to said first network element;
a network management system connected to said first and second network elements; and
wherein said first and second network elements each include means for encoding a unique identifier associated with each of said network elements, a processor coupled to said encoding means, and means for physical layer auto-discovery.

2. The system in accordance with claim 1 wherein said means for physical layer auto-discovery comprises:
a program storage device readable by a processor and tangibly embodying a program of instructions executable by the processor to perform a method of communicating connectivity information between said first and second network elements, the method comprising the steps:
sending a request packet at the physical layer from the first network element to the second network element;
receiving a respond packet at the physical layer in response to said sent request packet.

3. The system in accordance with claim 2 wherein said request packet comprises a first packet protocol identifier, a sequence number, and a first padding.

4. The system in accordance with claim 2 wherein said response packet comprises a second packet protocol identifier, said sequence number, a far end electronic serial number, a far end port identifier, and a second padding.

5. The system of claim 1 wherein said first network element is connected to said second network element by an optical fiber link.

6. A method for automatically discovering a network topology comprising the steps of:
assigning an electronic serial number and unique port identifier to a network element;
representing the network element in a network management system based on said assigned electronic number;
communicating connectivity information between the network element and a neighboring network element based on said assigned electronic serial number and unique port identifier; and
communicating said connectivity information to the network management system so that the connectivity information is associated with said representation of the network element.

7. The method in accordance with claim 6 wherein said step of assigning an electronic serial number comprises the steps of assigning a network element model number and a network element serial number.

8. The method in accordance with claim 6 wherein said step of representing the network element in a network management system comprises the step of assigning a CORBA object to the network element and associating the CORBA object with said assigned electronic serial number.

9. A network element comprising means for encoding an electronic serial number associated with each the network element, a processor coupled to said encoding means, and means for physical layer auto-discovery coupled to said processor and wherein said processor uses the encoded electronic serial number and the autodiscovery means to discover all other network elements linked to the network element.

10. A request packet for use in a physical layer auto-discovery protocol comprising a packet protocol identifier, a sequence number, and padding.

11. A response packet for use in a physical layer auto-discovery protocol comprising a packet protocol identifier, a sequence number, a far end electronic serial number, a far end port identifier, and padding.
